(19) United States
(12) Patent Application Publication
(10) Pub. No.: US 2015/0168440 A1
(43) Pub. Date: Jun. 18, 2015

(54) METHOD OF MEASURING ROTATING SPEED OF SPHERE USING ACCELEROMETER

(71) Applicant: KOREA AEROSPACE RESEARCH INSTITUTE, Daejeon (KR)

(72) Inventors: Wooyong Kang, Daejeon (KR); Dae-Kwan Kim, Daejeon (KR); Yong Bok Kim, Daejeon (KR); Hyungjoo Yoon, Daejeon (KR); Hong-Taek Choi, Daejeon (KR)

(73) Assignee: KOREA AEROSPACE RESEARCH INSTITUTE, Daejeon (KR)

(21) Appl. No.: 14/405,679

(22) PCT Filed: Dec. 7, 2012
(86) PCT No.: PCT/KR2012/010611

§ 371 Date: Dec. 4, 2014

(30) Foreign Application Priority Data
Jun. 8, 2012 (KR) 10-2012-0061661

(51) Int. Cl. G01P 15/02; G01P 3/00

(52) U.S. Cl. CPC G01P 15/02; G01P 3/00

(57) ABSTRACT

The present invention relates to a method of measuring the rotating speed of a sphere for controlling the posture of a satellite. The method includes: an accelerometer installing operation in which a pair of accelerometers is installed at each accelerometer coordinate axis, the accelerometers being located in the sphere; an accelerometer coordinate axis alignment operation in which the accelerometer coordinate axes are aligned to allow the accelerometer coordinate axes to be in line with system coordinate axes, respectively; an acceleration measuring operation in which a current is applied to an electromagnet to rotate the sphere and sequentially measure the acceleration; an acceleration calculating operation in which only the acceleration generated by the rotation of the sphere is calculated; and a rotating speed calculating operation in which the rotating speed of the sphere with respect to each coordinate axis is calculated using the acceleration.

### TECHNICAL FIELD

The present invention relates to a method of measuring a rotating speed, of a sphere which is used to control an attitude of a satellite, and more particularly, to a method of measuring a rotating speed of a sphere using an accelerometer, in which a plurality of accelerometers are installed in the sphere installed in an attitude control device to control an attitude of a satellite in three axial directions, and the rotating speed of the sphere is calculated using acceleration values .measured by the accelerometers.

### BACKGROUND ART

In a satellite such as an artificial satellite which acquires necessary information while making a constant orbit around the earth, an attitude control device is provided so that the satellite moves along the constant orbit. The attitude control device applies a driving force generated by a reaction wheel or a thruster to the satellite in a proper direction, as necessary, thereby controlling the attitude of the satellite.

In order to accurately and precisely control the attitude of the satellite, the driving force should be applied in three axial directions of X, Y and Z axes. Recently, as illustrated in FIGS. 1a and 1b, a study on a satellite attitude control device using a sphere is being carried out, in which the sphere is located at a center, and a plurality of electromagnets are arranged around the sphere at an angular interval of 90°, and a current is periodically applied to the electromagnet to form a magnetic field, and a Lorentz force is generated at the sphere, and thus a driving force is applied to the three axes, thereby controlling the attitude of the satellite,

However, to appropriately operate the satellite altitude control device using the sphere, first, it is necessary to measure a rotating direction and a rotating speed of the sphere. Conventionally, to measure the rotating speed of the sphere, a reflective sheet is attached on a surface of the sphere, and laser is irradiated to the reflective sheet, and a laser signal reflected from the reflective sheet is received and analyzed by a tachometer, and thus the rotating speed of the sphere is calculated. However, in this method, there is a disadvantage in that the tachometer is installed at each of the X, Y and Z axes, and thus a controller has a complicated structure.

In another method of measuring the rotating speed of the sphere, the rotating sphere is taken by camera to obtain an image thereof, and the obtained image is processed, and the rotating sphere is calculated. However, in this method, since additional devices such as the camera should be installed, it is not preferable to apply this method to the satellite which pursues low power consumption, a small size and a light weight thereof.

Therefore, the development of a method of measuring the rotating speed of the sphere, which is capable of precisely measuring the rotating speed of the sphere in a simple manner, is required.

### DISCLOSURE

### Technical Problem

The present invention is directed to providing a method of measuring a rotating speed of a sphere, which can precisely measuring the rotating speed of the sphere in a simple manner.

### Technical Solution

One aspect of the present invention provides a method of measuring a rotating speed of a sphere using an accelerometer, including an accelerometer installing operation in which a pair of accelerometers is installed at each accelerometer coordinate axis including x, y, and z axes orthogonal to one another, the accelerometers being located in die sphere; an accelerometer coordinate axis aligning operation in which the accelerometer coordinate axes are aligned to allow the x, y, and z axes of the accelerometer coordinate axes to match with the X, Y, and Z axes of system coordinate axes, respectively; an acceleration measuring operation in which a current is applied to an electromagnet installed around the sphere to rotate the sphere and sequentially measure an acceleration applied to each of the accelerometer x, y, and z axes; an acceleration calculating operation in which an acceleration component of gravity is removed from the acceleration measured in the acceleration, measuring operation and only the acceleration generated by rotation of the sphere is calculated; and a rotating speed calculating operation in which the rotating speed of the sphere with respect to each coordinate axis is calculated using the acceleration calculated in the acceleration calculating operation.

### Advantageous Effects

According to the present invention, since three pairs of accelerometers are installed in the sphere, and the rotating speed of the sphere is measured using acceleration values measured by the acceleration values, the rotating speed of the sphere can be simply and accurately measured more than the conventional method.

Further, according to the present invention, since the accelerometer coordinate axis exactly matches with the system coordinate axis, and then the acceleration value is measured, the rotating speed of the sphere can be more accurately measured.

### DESCRIPTION OF DRAWINGS

FIG. 1 is a schematic view of a sphere driving system for satellite attitude control.

FIG. 2 is a flowchart of a method of measuring a rotating speed of a sphere using an accelerometer according to the present invention.

FIG. 3 is a view illustrating an accelerometer coordinate axis aligning operation of the present invention.

FIG. 4 is a view illustrating an acceleration component measured when the sphere is rotated about an X axis.

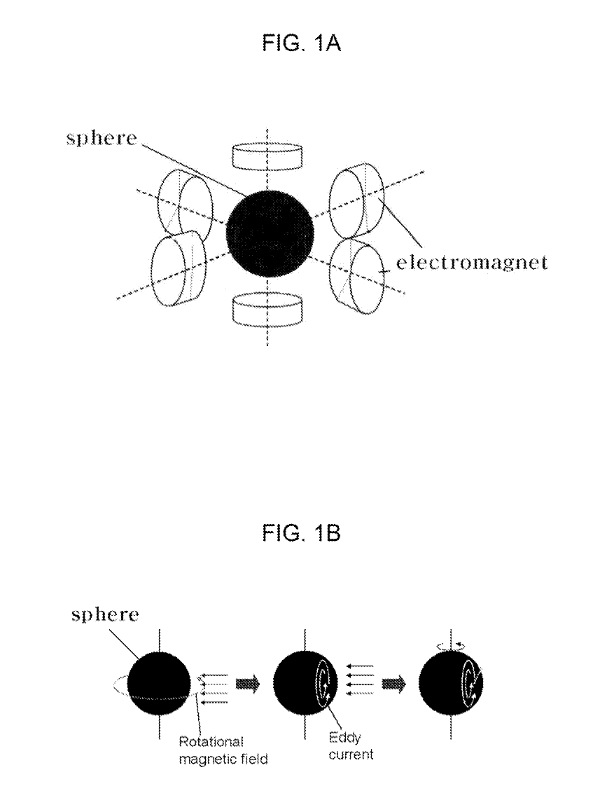

### MODE OF THE INVENTION

Hereinafter, exemplary embodiments of the present invention will be described in detail with reference to the accompanying drawings.

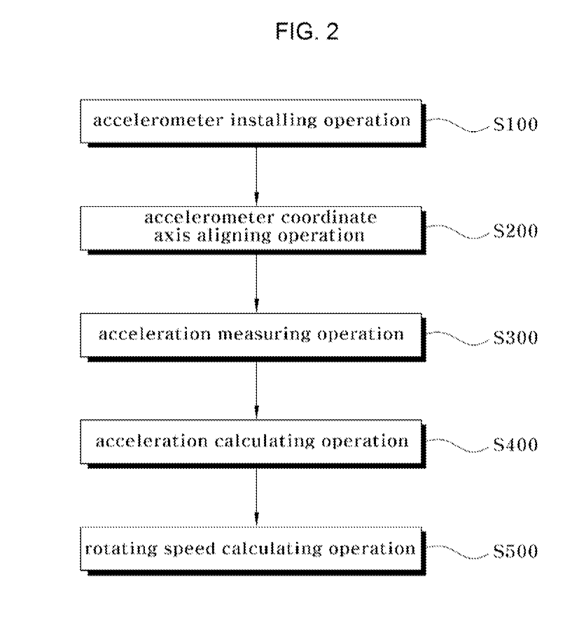

As illustrated in FIG. 2, a method of measuring a rotating speed of a sphere using an accelerometer according to the present invention includes an accelerometer installing operation S100, an accelerometer coordinate axis aligning operation S200, an acceleration measuring operation S300, an acceleration calculating operation S400, and a rotating speed calculating operation S500.

(1) Accelerometer Installing Operation S100

In the accelerometer installing operation S100, first, x, y and z axes which are orthogonal to one another are set in the sphere, and one pair of accelerometers acc_x1 and acc_x2, acc_y1 and acc_y2, and acc_z1 and acc_z2 is installed at each axis (each of the x, y and z axes). At this time, the origin of the x, y and z axes, at which the accelerometers are installed, is set so as to match with a center of the sphere.

At this time, since a value of a centripetal force is changed according to a radius of rotation, the accelerometers are installed at positions spaced exactly the same distance r₁, r₂ from the origin of the accelerometer coordinate axis, and thus an error when the acceleration is measured is prevented. The accelerometers acc_x1, acc_y1 and acc_z1 among them installed at each accelerometer x, y and z axis, which are installed at inner sides, are installed as near as possible to the origin of coordinates.

(2) Accelerometer Coordinate Axis Aligning Operation S200

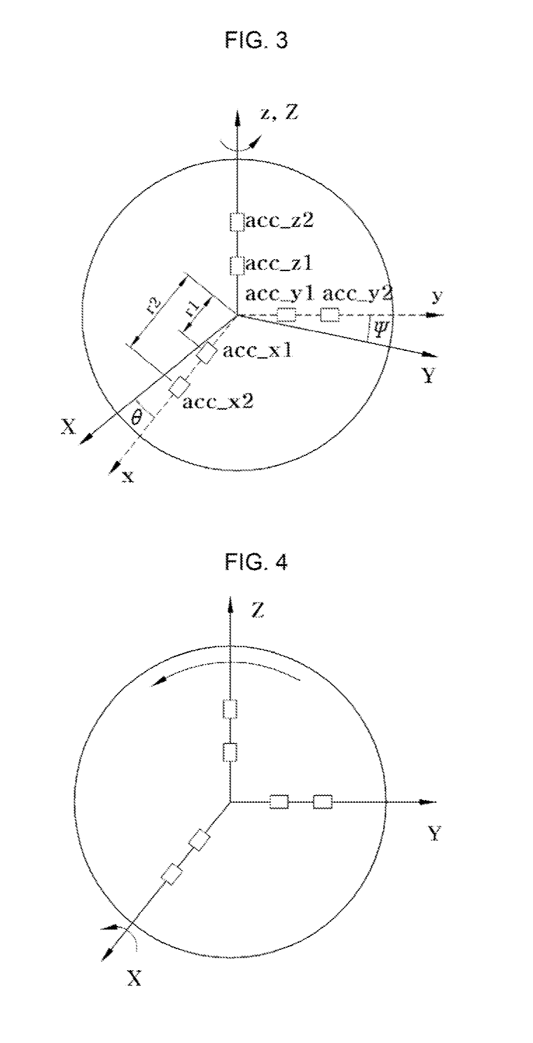

In the accelerometer coordinate axis aligning operation S200, when the three pairs of accelerometers are installed through the accelerometer installing operation S100, each x, y and z axis of coordinate axes (hereinafter, called ‘accelerometer coordinate axes’), at which the accelerometers are installed, is aligned so as to match with each X, Y and Z axis of coordinate axes (hereinafter, called ‘system coordinate axes’) of an entire system, as illustrated in FIG. 3.

When the sphere is rotated, the acceleration is generated by the centripetal force. At this time, when the acceleration coordinate axes and the system coordinate axes do not match with each other, i.e., are misaligned with each other, the acceleration is inaccurately measured. If the measuring of the acceleration is inaccurate, the rotating speed of the sphere to be finally obtained may not be accurately calculated.

Therefore, in the present invention, before the measuring of the rotating speed of the sphere is started, first, the x, y and z axes of the accelerometer coordinate axes match with the X, Y and Z axes of the system coordinate axes, such that the acceleration generated by rotation of the sphere may be accurately measured.

When one of the three axes matches with the direction of gravity to precisely align the accelerometer coordinate axes with the system coordinate axes, one side axes of the both coordinate axes may be easily aligned.

For example, if the accelerometer z axis and the system Z axis match with the direction of gravity of the sphere, the z and Z axis of the both coordinate axes matches with each other, and thus the accelerometer x and y axes and the system X and Y axes should be aligned to match with each other. However, it is not easy to manually perform an aligning operation in which the x(X) axis and y(Y) axis are aligned to match with each other, respectively. Even though such an aligning operation is manually performed, there may be a slight mismatch between the both coordinate axes.

Therefore, in the present invention, to match the accelerometer x and y axes with the system X and Y axes, respectively, except the direction of gravity (z(Z) axis), first, the accelerometer z axis and the system Z axis matches with the direction of gravity, and a current is sequentially applied to the electromagnets arranged around the sphere at the angular interval of 90° with respect to the z(or Z) axis, such that the sphere is rotated about the z(or Z) axis. A pitch (a deviation between the x axis and the X axis) angle and a roll (a deviation between y axis and Y axis) angle at this time are obtained by the following Equations 1 and 2, respectively. Then, when the accelerometer x and y axes are moved to and aligned with the system X and Y axes by the obtained values, the accelerometer coordinate axes completely match with the system coordinate axes.

$$Ψ = {tan}^{- 1} [ \frac{- {f}_{y}}{- {f}_{z}} ]$$

wherein Ψ is the roll angle, and f_{y} and f_{z} are y and z axial accelerations.

$$θ = {tan}^{- 1} [ \frac{{f}_{x}}{\sqrt{{f}_{y}^{2} + {f}_{z}^{2}}} ] \qquad [ Equation 2 ]$$

wherein θ is the pitch angle, and fₓ, f_{y} and f_{z} are x, y and z axial accelerations.

However, the fₓ, f_{y} and f_{z} in the Equations 1 and 2 are the x, y and z axial accelerations of the accelerometer, which may be expressed by the following Equation 3.

$$[ Equation 3 ]$$

$$\begin{matrix}{f}^{b} = {C}_{n}^{b} {f}^{n} \\ = [ \begin{matrix}cos θcos Ψ & cos θsin Ψ & - sin θ \\ sin ψsin θsosΨ - cos ψsin Ψ & sin ψsin θsinΨ + cos ψ cos Ψ & sin ψcos θ \\ cos ψsinθcosΨ + sin ψsinΨ & cos ψsin θsin Ψ - sin ψsin Ψ & cos ψcos θ\end{matrix} ] [ \begin{matrix}0 \\ 0 \\ - g\end{matrix} ] \\ = [ \begin{matrix}g sin θ \\ - g sin ψcosθ \\ - g cos ψcos θ\end{matrix} ] [ \begin{matrix}{f}_{x} \\ {f}_{y} \\ {f}_{z}\end{matrix} ]\end{matrix}$$

wherein f^{b} is an acceleration in a direction of b, i.e., a direction of the accelerometer coordinate axis, fⁿ is an acceleration in a direction of n, i.e.. a direction of the system coordinate axis, cₙ^{b} is a direction change vector, θ is the pitch angle, Ψ is the roll angle, fₓ, f_{y} and f_{z} are the x, y and z axial accelerations, and g is the acceleration of gravity.

(3) Acceleration Measuring Operation S300

In the acceleration measuring operation S300, when the accelerometer coordinate axes and the system coordinate axes are aligned through the accelerometer coordinate axis aligning operation S200, the current is sequentially applied to electric circuits of the system, which are arranged around the sphere at the angular interval of 90°, so as to rotate the sphere, and thus the centripetal force (centrifugal force) applied to the sphere is measured by the accelerometer, and a result thereof is transmitted to an external computer or the like.

In the present invention, instead of simultaneously measuring the acceleration applied to each of the three accelerometers by the centripetal force, the acceleration applied to each of the accelerometer x, y and z axes is obtained in turn.

To this end, first, the current is applied to four of six electromagnets, which are arranged in a direction orthogonal to the system X axis, according to the order of arrangement, such that the sphere is rotated about the X axis, as illustrated in FIG. 4.

As described above, if the sphere is rotated about the accelerometer x axis, the centripetal force is not generated at the x axis, but generated at only the y and z axes. As a result thereof, the acceleration is detected by the accelerometer installed at each of the axes.

Then, in the same manner as the above, the current is applied to four electromagnets arranged in a direction orthogonal to the system Y axis according to the order of arrangement, such that the sphere is rotated about the Y axis. And if the same operation is carried out with respect to the Z axis, the centripetal force is generated at only the z and x axes, and the x and y axes respectively, and the accelerations are detected by the accelerometers.

At this time, the 6 accelerations detected by the three pairs of accelerometers acc_x1 and acc_x2, acc_y1 and acc_y2, and acc_z1 and acc_z2 installed at each of the accelerometer coordinate axes are transmitted to the computer provided at the system though radio communication. To this end, a radio communication device is provided in the sphere.

(4) Acceleration Calculating Operation S400

Acceleration components of gravity are included in the accelerations measured through the acceleration measuring operation S300, and thus in the acceleration calculating operation S400, the acceleration components of gravity are removed from the measured accelerations, and only the accelerations generated by the rotation of the sphere are calculated.

First, when the sphere is rotated about the X axis, the accelerometers installed at the x axis output the acceleration of 0, and the accelerometers installed at the y and z axes output accelerations in which the acceleration of gravity is added to the acceleration generated by the centripetal force due to an influence of the acceleration of gravity.

However, since the sphere is rotated about the system X axis, the acceleration of gravity applied to the accelerometers installed at the accelerometer y and z axes is increased and reduced in the formed of a sine wave. At this time, the acceleration of gravity applied to the accelerometers installed at the same axis, e.g., the pair of accelerometers acc_y₁ and acc_y₂ installed at the y axis is increased and reduced in the formed of a sine wave, while having the same phase and the same value, and thus when the accelerations output from the pair of accelerometers acc_y₁ and acc_y₂ installed at the same axis through the acceleration calculating operation S400 are differentiated, only the accelerations due to the rotation of the sphere may be extracted, and the same manner may be performed with respect to the z axis.

Then, when the sphere is rotated about the system Y axis, the pair of accelerometers acc_y₁ and acc_y₂ installed at the y axis output the acceleration of 0, and the accelerometers acc_x1 and acc_x2, and acc_z₁ and acc_z₂ installed at the x and z axes output accelerations in which the acceleration of gravity is added to the acceleration generated by the centripetal force due to the influence of the acceleration of gravity. Therefore, in this case, as described above, the accelerations output from each pair of accelerometers acc_x1 and acc_x2, and acc_z1 and acc_z2 installed at the same axis through the acceleration calculating operation S400 are differentiated, and thus only the accelerations due to the rotation of the sphere are extracted.

Lastly, when the sphere is rotated about the system Z axis which coincides with a gravity acting direction, the accelerometers acc_z1 and acc_z2 installed at the z axis output accelerations corresponding to the acceleration of gravity, and since the accelerometers acc_x1 and acc_x2, and acc_y1 and acc_y2 installed at the x and y axes are not affected by the acceleration of gravity, only the accelerations generated by the centripetal force are detected and output. Therefore, in this ease, instead of differentiating the accelerations measured through the acceleration calculating operation S400, the accelerations detected by the accelerometers may be used as they are.

(5) Rotating Speed Calculating Operation S500

In this operation, the rotating speed of the sphere with respect to each coordinate axis is calculated from the accelerations calculated through the acceleration calculating operation S400.

The values calculated in the acceleration calculating operation S400 are accelerations rω2 (wherein r=r₂−r₁), and the rotating speed ω of the sphere in a direction of each coordinate axis may be calculated with each of the acceleration components.

Although a few embodiments of the present invention have been shown and described, it would be appreciated by those skilled in the art that changes may be made in these embodiments without departing from the principles and spirit of the invention, the scope of which is defined in the claims and their equivalents.

1. A method of measuring a rotating speed of a sphere, which is installed in an attitude control device to control an attitude of a satellite in three axial directions, using an accelerometer. comprising:
an accelerometer installing operation (S100) in which a pair of accelerometers is installed at each accelerometer coordinate axis including x, y, and z axes orthogonal to one another, the accelerometers being located in the sphere;
an accelerometer coordinate axis aligning operation (S200) in which the accelerometer coordinate axes are aligned to allow the x, y, and z axes of the accelerometer coordinate axes to match with the X, Y, and Z axes of system coordinate axes, respectively;
an acceleration measuring operation (S300) in which a current is applied to an electromagnet installed around the sphere to rotate the sphere and sequentially measure an acceleration applied to each of the accelerometer x, y, and z axes;
an acceleration calculating operation (S400) in which an acceleration component of gravity is removed from the acceleration measured in the acceleration measuring operation (S300) and only the acceleration generated by rotation of the sphere is calculated; and
a rotating speed calculating operation (S500) in which the rotating speed of the sphere with respect to each coordinate axis is calculated using the acceleration calculated in the acceleration calculating operation (S400).

2. The method of claim 1, wherein the aligning of the accelerometer coordinate axes in the accelerometer coordinate axis aligning operation (S200) is achieved by matching one of the accelerometer coordinate axes with one of the system coordinate axes, obtaining a roll angle and a pitch angle of the accelerometer coordinate axes based on the matched axis, and then moving the accelerometer coordinate axes to the system coordinate axes by the obtained roll angle and pitch angle.

3. The method of claim 2, wherein the roll angle and the pitch angle of the accelerometer coordinate axes are calculated by the following Equations 1 to 3.
$$Ψ = {tan}^{- 1} [ \frac{- {f}_{y}}{- {f}_{z}} ] \qquad [ Equation 1 ]$$
wherein Ψ is the roll angle, and f_{y} and f_{z} are y and z axial accelerations,
$$θ = {tan}^{- 1} [ \frac{{f}_{x}}{\sqrt{{f}_{y}^{2} + {f}_{z}^{2}}} ] \qquad [ Equation 2 ]$$
wherein θ is the pitch angle, and fₓ, f_{y} and f_{z} are x, y and z axial accelerations, and
$$[ Equation 3 ]$$
$$\begin{matrix}{f}^{b} = {C}_{n}^{b} {f}^{n} \\ = [ \begin{matrix}cos θcos Ψ & cos θsin Ψ & - sin θ \\ sin ψsin θsosΨ - cos ψsin Ψ & sin ψsin θsinΨ + cos ψ cos Ψ & sin ψcos θ \\ cos ψsinθcosΨ + sin ψsinΨ & cos ψsin θsin Ψ - sin ψsin Ψ & cos ψcos θ\end{matrix} ] [ \begin{matrix}0 \\ 0 \\ - g\end{matrix} ] \\ = [ \begin{matrix}g sin θ \\ - g sin ψcosθ \\ - g cos ψcos θ\end{matrix} ] [ \begin{matrix}{f}_{x} \\ {f}_{y} \\ {f}_{z}\end{matrix} ]\end{matrix}$$
wherein f^{b} is an acceleration in a direction of b, i.e., a direction of the accelerometer coordinate axis, fⁿ is an acceleration in a direction of n, i.e., a direction of the system coordinate axis, cₙ^{b} is a direction change vector, θ is the pitch angle, Ψ is the roll angle, fₓ, f_{y} and f_{z} are the x, y and z axial accelerations, and g is the acceleration of gravity.

4. The method of claim 2, wherein, when the one of the accelerometer coordinate axes matches with the one of the system coordinate axes in the accelerometer coordinate axis aligning operation (S200), the one of the accelerometer coordinate axes and the one of the system coordinate axes match with a direction of gravity.

5. The method of claim 4, wherein, when the sphere is rotated about the system X axis, the acceleration output from each of the pair of accelerometers acc_y1 and acc_y2, acc_z1 and acc_z2 installed at the same axis through the acceleration calculating operation (S400) is differentiated, and
when the sphere is rotated about the system Y axis, the acceleration output from each of the pair of accelerometers acc_x1 and acc_x2, acc_z1 and acc_z2 installed at the same axis through the acceleration calculating operation (S400) is differentiated, and
when the sphere is rotated about the system Z axis which coincides with the direction of gravity, instead of differentiating the accelerations measured through the acceleration calculating operation (S400), the accelerations detected by the accelerometers are used as they are.
